(19) United States
(12) Patent Application Publication
(10) Pub. No.: US 2013/0329355 A1
(43) Pub. Date: Dec. 12, 2013

(54) Scalable hardware architecture, scalable cooling system, and convection-cooled electrical circuit

(71) Applicant: Michal Polubinski, Mississauga (CA)

(72) Inventor: Michal Polubinski, Mississauga (CA)

(73) Assignee: Victoria Isabella Polubinska, Mississauga (CA)

(21) Appl. No.: 13/916,548

(22) Filed: Jun. 12, 2013

Related U.S. Application Data
(60) Provisional application No. 61/658,468, filed on Jun. 12, 2012.

(51) Int. Cl. G06F 1/20

(52) U.S. Cl. CPC G06F 1/206
USPC 361/679.46

(57) ABSTRACT

A unified scalable hardware system architecture contains subsystems which can be made available to a user depending on demand, a status of user's subscription or on a level of acquired licenses. This allows achieving manufacturing economies of scale with flexible monetization policies depending on the subscribed service level.

An electric circuit such as a microprocessor system or a semiconductor control device includes a set of channels coupled to a source of a cooling medium and to an external heat exchanger. This cooling medium may be composed of a single or multi-phase liquid, gas, or mixture of any of the said media with solid particles flowing within an integrated circuit (IC) enclosure tangent to the said IC or across the integrated circuit structure through a set of microchannels.

A scalable microprocessor system adjusts the number of active cores to the capability of a docking station to dissipate waste heat. In the absence of an active external heat sink, the number of active cores is reduced to limit the core temperatures to predefined values.

### BRIEF DESCRIPTION OF THE INVENTION

The purpose of the invention is to facilitate the adaptable use of an electronic or an electric device, an assembly, a subsystem a system and associated methods, further called ‘the means’. The adaptability is governed by several factors:

The availability of external energy to power the means,
The availability of the environment to dissipate the unwanted energy,
The business status of acquired licenses, permits and subscriptions,
The demand for operational and functional capabilities of the means.

As the result of utilizing the provisions of this invention, the costs of manufacturing may be reduced and the operational characteristics of the means can be adjusted for the optimal efficiencies.

When applied to stationary configurations of the means, the power density can be increased and the energy recovery enhanced as defined in claim 3.

In mobile configurations (such as a smartphone, a tablet computer, a document reader, etc.) the invention provides scalability in a multi-core mode (such as scalable 100 core processor announced by Tilera ⁱ), where the dissipation of the excessive heat can be maintained within acceptable limits depending on temporal energy dissipating capabilities of the environment.

These goals can be achieved by redesigning the prior art of a mobile device in such a manner that the multi-core processor is thermally coupled to either an external or internal (as a part of a processor) thermally-conducting interface providing heat sinking capability through an external docking station.

The docking station (see claim 2) contains, as a minimum, a heat sink and/or a solid, gaseous, liquid or semiliquid thermal interface (such as a heat sink plate or a cooling liquid-filled pouch, or quick connect tubing carrying gaseous or liquid coolant). The heat sink may be cooled by air, water, Peltier effect, or any other method for transferring the heat to an external sink.

The liquid coolant (such as deionized water, etc.) can be circulated through a thermal contact plate within the docking station, or directed through the portable device's internal conduits. The latter option provides an increased heat dissipation capability without adding any weight. This option requires optional snap-in connectors to place the portable device in the docking station and a process to remove the coolants from the internal conduits prior to disconnecting the portable device from the docking station—to prevent any spills of the liquid coolant.

Additionally, the docking station may provide power to the portable electronic device through a conductive path, or through electromagnetic transmission such as a current loop, i.e. near-field antenna.

The prior art may be used to provide an integrated or external data transmission channel to ensure data flow between the mobile device and the docking station. Data may be transmitted using a Bluetooth, WiFi, infrared or any other technology with or without external transceivers. The docking station may be equipped with memory devices such as solid state memories, hard disk drives, DVD writers or any other devices. The docking station may embody a Graphic User Interface such as a monitor screen, with or without touch screen technology, an Acoustic User Interface, or a Motion User Interface, or any other user interface.

The invention as applied to a mobile device is beneficial to business people, engineers, researchers, designers, gamers, etc., who might have a high demand for mobility and computing power. With present restrictions on carry-on baggage enforced by airlines, a smartphone and a docking station can be carried in a traveler's carry-on baggage. Thus, the functionality of a 100-core processor can be attained in a compact, travel-sized package. When connected together, the smartphone-docking station combo can be particularly useful in the virtual environment providing capabilities of various operating systems. It can be connected to various displays such as 3D or holographic imaging which require additional computing power.

The docking station may include networking, video, sound, telemetry, or any other interfaces used to measure physical parameters in the field, a laboratory, or in production environment.

The direct cooling methods presented in this description may be utilized in electric power control such as in electric vehicles, regenerative brakes (hybrid vehicles) rail transport (locomotives) or power switching and distribution systems.

Convection cooling improves the capability of dissipating the waste heat. The simplest solution involves running a cooling medium in the space between an integrated circuit and its enclosure. The next level involves passing the cooling medium through microchannels fabricated across the structure of the integrated circuit. Alternatively, heat pipes may be directly built-in the heat-generating devices.

Spent thermal energy may be converted to electrical energy using any of prior art technologies, materials and devices such as graphene, a thermoelectric generator, a thermocouple, a multiferroic alloy, such as, but not limited to, Ni45Co5Mn40Sn10ⁱⁱa, or with the use of a multitude of the said devices.

Optionally, the flow of the cooling medium may be assisted by a pump, as indicated in claim 8.

### SHORT DESCRIPTIONS OF DRAWINGS

The drawings and captions are listed below:

FIG. 1: Embodiment of a smartphone with the exposed thermal interface;

FIG. 2: Smartphone placed on a heat sink;

FIG. 3: Smartphone placed on a docking station with a heat sink

FIG. 4: Internal cooling with lateral flow;

FIG. 5: Internal cooling with transversal flow;

FIG. 6: Physical conditions for the derivation Equation (1) The physical conditions for derivation of Equation (1)

FIG. 7: Power density for leading-edge microprocessors

### DESCRIPTION OF DRAWINGS

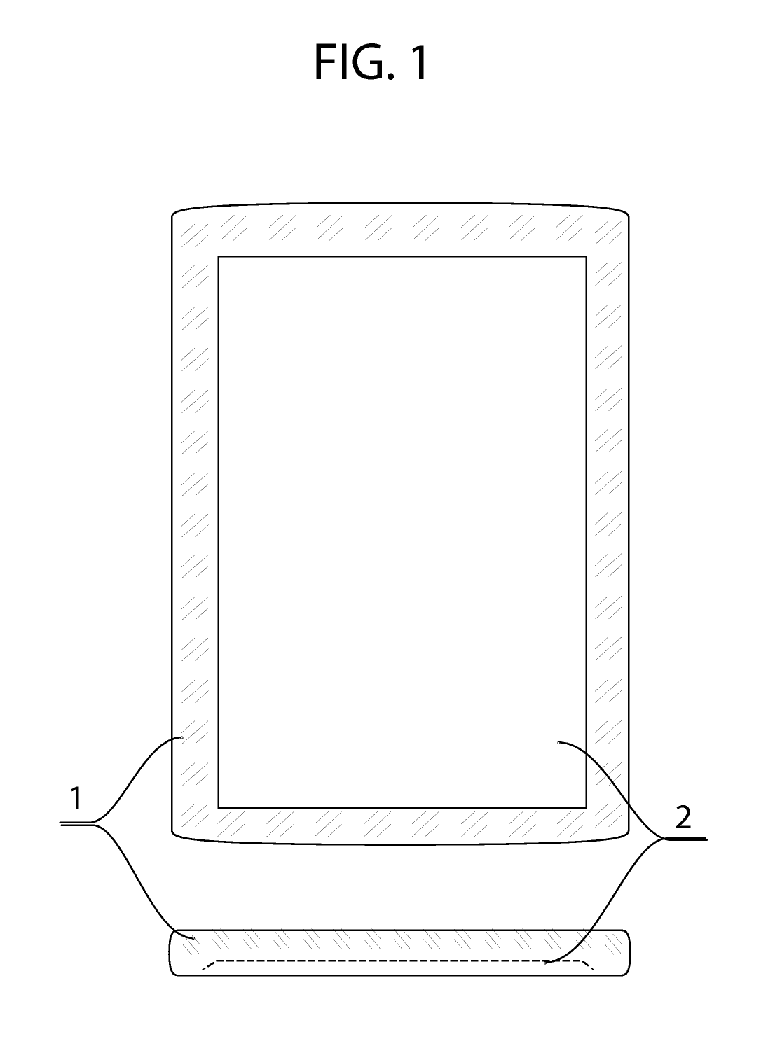

FIG. 1 shows a possible embodiment of a smartphone (1) with an exposed thermal interface (2).

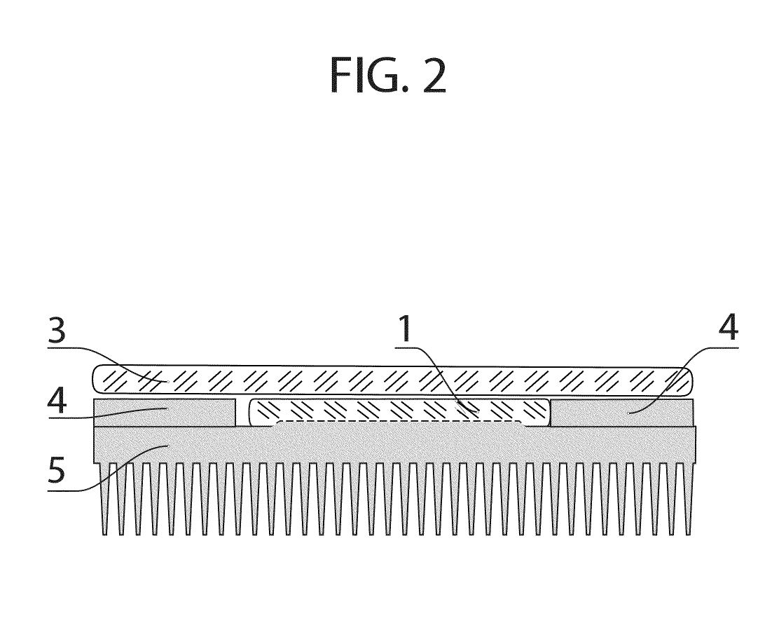

FIG. 2 illustrates another possible embodiment of this invention. A smartphone (1) is placed on the top of the heat sink (5), surrounded by the electronics of the docking station (4) and covered by monitor screen (3).

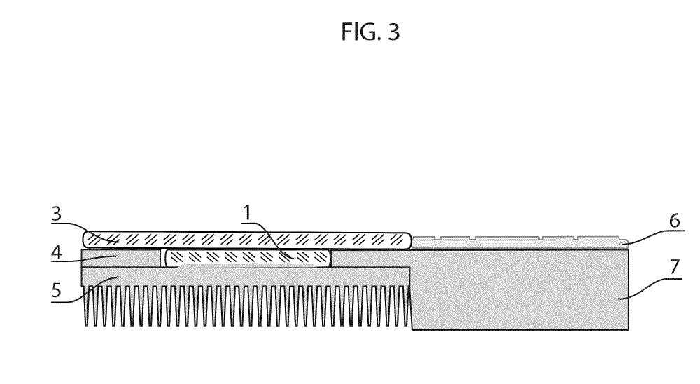

FIG. 3 exemplifies another implementation of the invention. The functionality of the configuration shown in FIG. 2 is enhanced by an extended compartment (7) which may contain additional components providing enhanced functionalities, such as extended storage, audio circuits, 3D display circuits, etc. and a tactile keyboard (6).

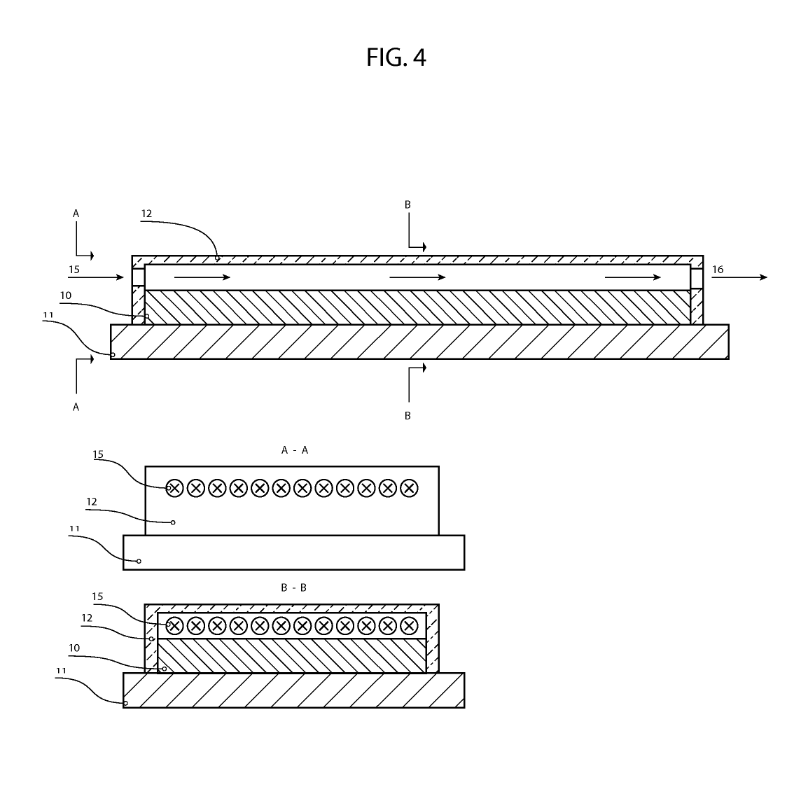

In FIG. 4, the integrated circuit (10) is placed in an enclosure made of a base plate (11) and a cover (12). The cooling medium flows in through openings (15) and flows out through openings (16). A-A represents a side view and B-B is a cross-section of this configuration. The heat is transported by a predominantly conductive heat transfer mechanism to the surface of the integrated circuit (10) and then by convection from the surface of the integrated circuit (10).

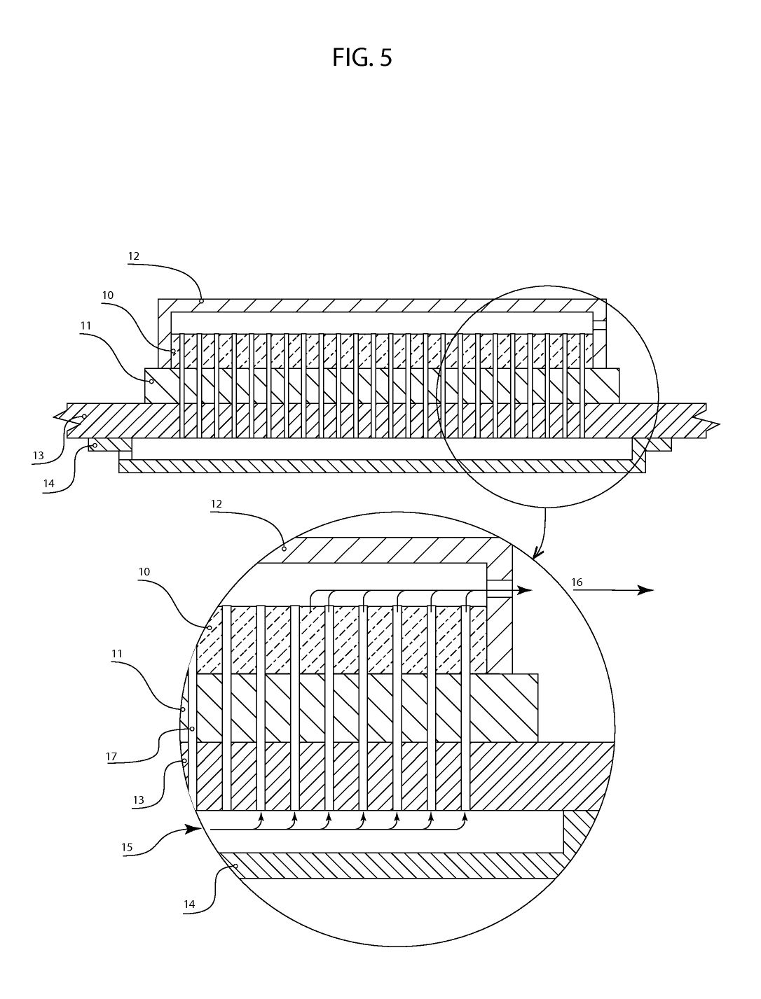

FIG. 5 represents a more efficient heat transfer configuration. The average conductive path starts at the body of the integrated circuit (10) and ends at the boundary of a microchannel (17). The backplate (14) directs the flow of the cooling medium to the microchannels, while the cover (12) channels the flow of the heated cooling medium. The direction of the flow can be reversed without any significant influence on the heat transfer mechanism. The cavity provided by the backplate (14) may be fabricated as an integral part of a base plate (11).

### PRIOR ART

The trend to increase the computing power of computing devices results in increasing the level of complexity of integrated circuits, by increasing the number of cores in multiprocessor chips and by increasing the density of devices on substrates. Several problems arise as the result of these trends.

“The problem with cramming more cores onto processors is that energy efficiency doesn't scale with the number of cores stacked onto chips. As more cores are added, power consumption grows faster than performance.

If you were to put a 16-core processor into your average modern smartphone, the maximum battery life would fall to three hours, while if you used a 100-core processor it would drop to just one hour, according to back-of-an-envelope calculations by a team of researchers from UK universities.

Tackling the rapacious appetite for power of many-core processors is relevant to more than just letting computers do more on the move. As an increasing number of cloud services such as Gmail, Salesforce.com and Spotify are accessed over the internet the need to keep down the energy demands of datacentres full of densely packed server clusters is also becoming pressing.

If unaddressed, the rising power consumption of many-core processors may limit future increases in computing performance, with predictions that within three processor generations CPUs will need to be designed to use as little of 50 percent of their circuitry at one time, to limit energy draw and prevent waste heat from destroying the chip.ⁱⁱⁱ

Various models of computers and computer systems are configured with varying hardware components. The components are either fixed (integrated with the others) or modular, such as hard drives, solid state drivers, monitors and microprocessors. In the process of manufacturing microprocessors, the maintenance of various sets of tools, processes, testing equipment and documentation increases the cost of manufacturing. The user is then compelled to purchase a new device once the original is perceived to be obsolescent, does not have sufficient capacity to run updated versions of software, or has been broken.

The ability to cool a processor is determined by its thermal resistance. Power is dissipated at the bottom side of the chip, with most of the heat being dissipated through the top side. Most of the heat must pass through the silicon die, heat spreader, heatsink, then out to air, with some form of thermal interface material in the interface between each of those. The overall thermal resistance can be measured by measuring the power dissipation and total temperature difference between the on-die temperature sensors and ambient air.

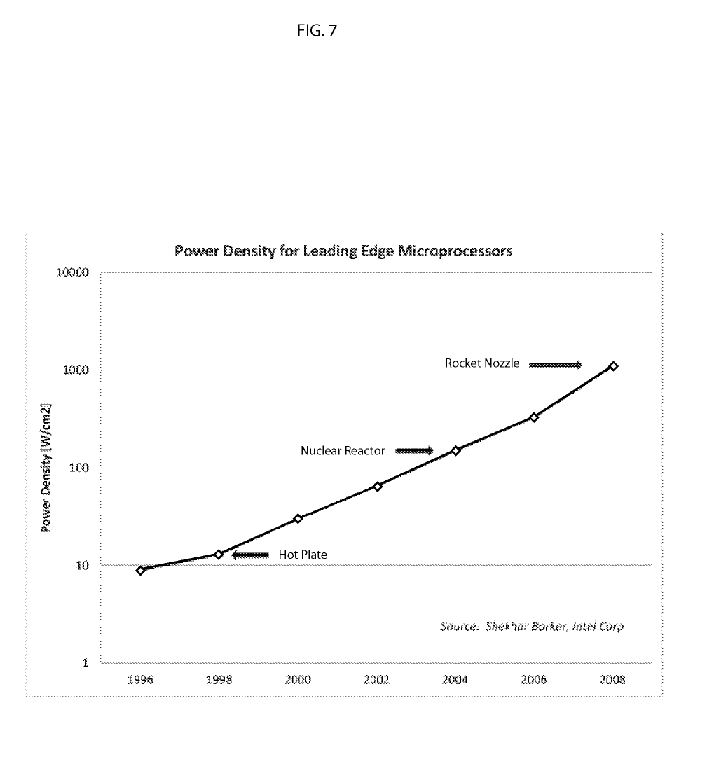

The limiting factor in the development of high power electronic assemblies is the increasing power density. The trend can be seen in FIG. 7. While in case of integrated circuits, the resolution of the fabricating process by lowering the operating voltage and currents lowers the dissipated heat, power semiconductors cannot claim this benefit. Dissipation of power density exceeding 1 kW/cm² becomes unmanageable using prior art technology—conductive heat transfer^{iv}

“The chip junction temperature in an actual computer environment can be predicted using Equation (1):

Tj=Tambient+dTambient-heatedair+dTcase-heatedair+dTj-case

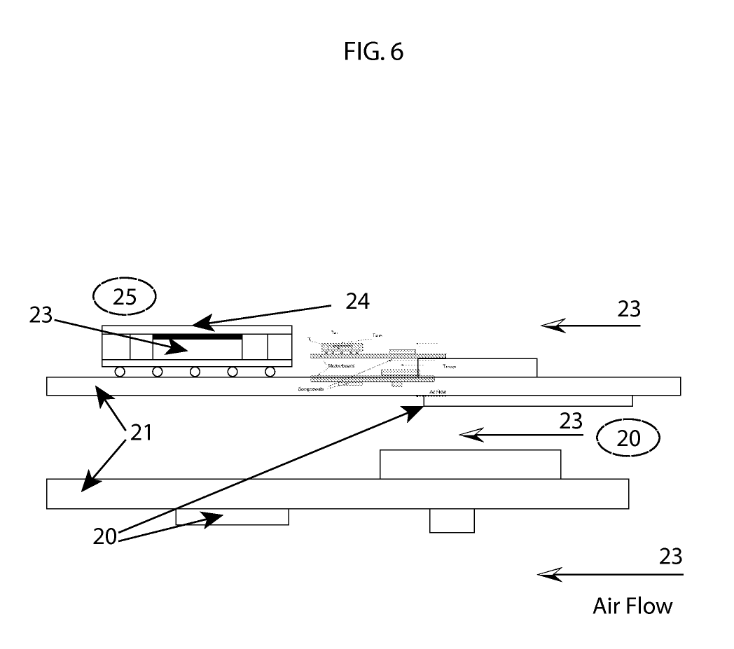

This equation states that the junction temperature rise above ambient temperature comprises the rise due to air heat-up, rise from the local bulk air near the heat sink base or module case (when there is no heat sink) to the heat sink base or module case, respectively (dTcase-heatedair); and the rise from the heat sink base or module case to the junction of the chip (dT j-case). The air heat-up can be caused by heated upstream components and/or the power dissipated by the air-moving device. The temperature rise from the local air to the module case depends on the convection boundary layer which is a comprehensive heat transfer/fluid flow topic in itself. The physical conditions for the derivation of Equation (1) are schematically shown in FIG. 6.

In FIG. 6, the components (20) are placed on a motherboard (21). The environmental variables that affect each of the terms in Equation (1) are briefly listed below:

Tambient (22) depends on such factors as atmospheric conditions and altitude.

dTamb-heatedair is a function of air-flow (23) rate, air density, humidity, component location, dissipated power of upstream components and board thermal properties.

The difference dT case-heatedair=Tcase (24)−Theatedair (25) is determined by system parameters, air-flow (23) rate, board parameters, air flow distribution, convection coefficient, component parameters and package construction.

The difference dT j-case depends on system parameters, board parameters, convection coefficient and package construction^{v}

The deficiencies and shortcomings of prior art are addressed in the following patents and patent applications:

In U.S. Pat. No. 8,405,998 ^{USP1}, the inventors envisioned a static system of cooling grooves extending throughout a three-dimensional VLSI device.

US Patent Application 20080310111^{USPA1} describes a “Transpiration cooling for passive cooled ultra-mobile computer”, again a static system, not capable to adjust its properties to the environment.
In US Patent Application 20120273183^{USPA2}, the inventors focused their efforts to define a “Coolant pumping system for mobile electronic systems”—essentially a pump which derives energy from inertia.
US Patent Application 20130090888^{USPA3}, defines a system where user's proximity controls the thermal properties of a mobile system.
The variable power delivery is defined in US Patent Application 20120329410^{USPA4}. In that embodiment, delivered power is adjusted to match the current thermal dissipation of a device.
In US Patent Application 20120236495^{USPA4}, Rajiv K. Mongia describes a fixed arrangement to augment the performance of a cooling system with a heat exchanger.

### THE INVENTION

The configuration of the hardware depends on a multitude of factors as indicated in Section 0. The grouping of hardware architecture variants into a scalable configuration reduces the complexity of the design, manufacturing, and testing processes. Also, this allows manufacturers to decrease the number of designs, with each design covering the wide range of configurations. This will enable longer runs of hardware and benefit from economies of scale. Operational benefits include the adaptability and scalability of offered products.

Examples of this invention may include but are not limited to a design with single-core processor and limited RAM, which can be soft-upgraded to a multiple-core processor with bigger RAM and cache memory after changing the subscription level or paying a one-time upgrade fee by the user.

The invention enables an application of a subscription model to the hardware. The hardware would be priced at a modular level. All customers would have an option to purchase the basic configuration and then buy or subscribe to more functions or higher performance parameters of a device modular components in order to match the device's specification to their current needs. Ultimately, the devices can be run in Just-In-Time-Configuration mode.

The invention improves the rate of heat dissipation by reducing the thermal resistance between the heat source and the coolant by shortening the thermal path from the source of the heat such as an integrated circuit, to a moving coolant. The temperature of the integrated circuit (chip junction) in an actual computer environment can be evaluated using Equation 1:

T_{IC}=T_{AMBIENT}+dT_{COOLANT-AMBIENT}+dT_{IC-COOLANT} a.

This equation states that the integrated circuit (junction) temperature rise above ambient temperature comprises the rise due to coolant heat-up, the rise from the local bulk coolant flowing next to the integrated circuit (the junction) of the chip (dT_{IC-COOLANT}). The coolant heat-up can be caused by heated upstream components and/or the power dissipated by the coolant-moving device. The temperature rise from the cooling medium to the integrated circuit depends on the convection boundary layer which is a comprehensive heat transfer/fluid flow topic in itself.

The terms in Equation 1 and their interactions are explained below: T_{AMBIENT}—is an ambient temperature, or the temperature of the external heat sink; dT_{COOLANT-AMBIENT}—is defined as the difference of temperatures between the temperature of the coolant and ambient temperature. It depends on such factors as the coolant-flow rate, heat flow from the coolant to the sink, coolant heat capacity, sink heat capacity; dT_{IC-COOLANT}—is the difference between the temperature of integrated circuit. It is affected by dissipated power of the integrated circuit, heat flow from the integrated circuit to the coolant, coolant heat capacity and the coolant flow rate.

Comparing to prior art arrangements, the path from the heat source (junction, integrated circuit, or electrical circuit) to the heat sink is much shorter and the capacity to dissipate the waste heat is much higher. Effectively, the heat resistance through the packaging or the module case is not affecting the temperature of the integrated circuit.

This invention involves several options:

A motherboard with embedded microchannels facilitating the dissipation of heat through heat convection to the predominant sink such as, but not limited to: the atmosphere, body of water, a container filled with fluid or gas or a radiators such as on a satellite;

An integrated circuit with the flow of cooling medium between the dice and the enclosure such as shown in FIG. 4;

An integrated circuit with microchannels across its volume as it can be seen in FIG. 5

### REFERENCES

ⁱ Tilera, (Tilera Corp., 2013)
ⁱⁱ (VIJAY SRIVASTAVA, 2011)
ⁱⁱⁱ (Heath, 2013)
^{iv} Kubiatowicz, http://www.cs.berkeley.edu/~kubitron/courses/cs252-S12/lectures/lec01-intro.pdf
^{v} http://www.electronics-cooling.com/1998/05/interaction-of-the-system-and-module-level-thermal-phenomena-a-flip-chip-bga-example/
P. Dunn and D. A. Reay, “Heat Pipes,” 4th Edition, Oxford, Burlington, 1994.
F. Tardy and Samuel M. Sami, “Thermal Analysis of Heat Pipes during Thermal Storage,” Applied Thermal Engineering, Vol. 29, No. 2-3, 2009, pp. 329-333. doi:10.1016/j.applthermaleng.2008.02.037
H. Jouhara, O. Martinet and A. J. Robinson, “Experimental Study of Small Diameter Thermosyphons Charged with Water, FC-84, FC-77 & FC-3283,” 5th European Thermal-Sciences Conference, Eindhoven, 18-22 May 2008.
H. Imura, H. Kusada, J. Oyata, T. Miyazaki and N. Sakamoto, “Heat Transfer in Two-Phase SClosed Thermosyphon,” Transactions of Japan Society of Mechanical Engineers, Vol. 22, 1977, pp. 485-493.
S. H. Noie, M. H. Kalaei and M. Khoshnoodi, “Experimental Investigation of Boiling and Condensation Heat Transfer of a Two Phase Closed Thermosyphon,” International Journal of Engineering, Vol. 18, No. 1, 2005, pp. 37-43.
D. E. Briggs and E. H. Young, “Convection Heat Transfer and Pressure Drop of Air Flowing across Triangular Pitch Banks of Finned Tubes,” Chemical Engineering Progress Symposium Series, Vol. 59, No. 41, 1963, pp. 1-10.
R. E. Simons, “Estimating Parallel Plate-Fin Heat Sink Thermal Resistance,” Calculation Corner-Electronics Cooling, 2000.
A. Pal and Y. Joshi, “Design and Performance Evaluation of a Compact Thermosyphon,” Proceedings of the International Conference Thermes 2002, Santa Fe, 13-16 Jan. 2002.
G. R. Warrier, V. K. Dhir, L. A. Momoda, Heat transfer and pressure drop in narrow rectangular channel, Experimental Thermal and Fluid Science 26 (2002) 53-64.
W. Qu, I. Mudawar, Flow boiling heat transfer in two-phase micro-channel heat sinks—I. Experimental investigation and assessment of correlation methods, International Journal Heat and Mass Transfer 46 (15) (2003) 2755-2771.
M. E. Steinke, S. G. Kandlikar, An experimental investigation of flow boiling characteristics of water in parallel microchannels, ASME Journal of Heat Transfer 126 (2004) 518-526.
J. Lee, I. Mudawar, Two-phase flow in high-heat-flux micro-channel heat sink for refrigeration cooling applications: Part Il-heat transfer characteristics, International Journal of Heat and Mass Transfer 48 (5) (2005) 941-955.
P.-S. Lee, S. V. Garimella, Saturated flow boiling heat transfer and pressure drop in silicon microchannel arrays, International Journal of Heat and Mass Transfer 51 (3-4) (2008) 789-806

1. A device, an assembly, a subsystem, or a system and methods (the means) wherein the number of and/or the performance properties of active components such as but not limited to, processor cores, thyristors depend on such factors as, but not limited to, demand, permissions governed by permits, a license level or a status of a subscription or/and on the flows of energy from and to the environment of the said means or an a multitude of the said factors.

2. The means as claimed in 1 wherein the energy flows are adjusted to match the properties of thermal interfaces and the environment of the said means, which is characterized by two exclusive states: a mobile state in which the said device is not connected to or linked with any external means such as, but not limited to a docking station, a device, a subsystem, or a system and methods, or a stationary state, when it is in connection with or linked to the said external means.

3. The means as in claim 2, wherein a part of the dissipated heat is converted into electrical energy with the use of the means such as, but not limited to, a nanostructure such as but not limited to graphene, a thermoelectric generator, a thermocouple, a multiferroic alloy, or with the use of a multitude of the said devices.

4. The means of claim 2 wherein the dissipated thermal energy is transferred through the heat pipe, heat convection or a combination of the heat convection and other means.

5. The heat pipe as claimed in 4 filled with nanostructures such as, but not limited, to nanotubes, graphene or silicene.

6. The means as claimed in 4 fitted with heat pipes, and/or comprising spaces (recesses, grooves, channels, microchannels, a multitude of holes, vias, etc.) capable of being filled with a medium including such as, but not limited to, deionized water, a single-phase medium (liquid, gas), a multi-phase medium (refrigerant, low-temperature/pressure boiling point liquid), or a mixture of liquid and/or gas with particles (nanofluid) and excluding non-treated water.

7. The means as claimed in 6 wherein the said medium flows through said spaces across the structure of the said electrical circuit.

8. The means as claimed in 4 wherein the said medium flow is assisted by a device such as, but not limited to, a mechanical, an ionic, a magneto-hydrodynamic, or a ferrofluidic pump.
